(19) United States
(12) Patent Application Publication
(10) Pub. No.: US 2008/0229552 A1
(43) Pub. Date: Sep. 25, 2008

(54) Zipper connection between kite sail material and structural members

(76) Inventor: Wes Cameron Martin, Chesapeake, VA (US)

Correspondence Address: WES MARTIN, 602 B ST., CHESAPEAKE, VA, 23324, US

(21) Appl. No.: 11/687,733

(22) Filed: Mar. 19, 2007

(51) Int. Cl. A44B 19/00; B64C 31/06

(52) U.S. Cl. 24/381; 244/153 R

(57) ABSTRACT

The present invention comprises one functional addition to kite's sail material and structural spars. This invention uses a zipper rather than kite sail material pockets to attach the structural spars to the sail material. This invention is specific to the functional kite spars and the sail material that attaches to them. One side of the zipper is attached permanently or non-permanently to kite spars. The other side of the zipper is permanently attached to the kite material. This allows easy disassembly of the kite material from its structural spars. This also functionally attaches the desired portion of kite material to its structural spar without the use of pockets or material stretching.

### BACKGROUND OF THE INVENTION

The present invention pertains to a useful improvement in the way that kite material is attached to the structural members and helps creates even tension in the material. The art of making kites includes the use of pockets that hold the structural members inside of the kite material. Many patents show innovation in the way these pockets are designed. Pocket designs show innovation in the hemming methods designs and also the sleeve ends.

### DESCRIPTION OF THE RELATED ART

Kites consist of spars and sail material. The art of attaching the spars to the sail material is normally accomplished by the use of pockets. These pockets have an opening at one end for the spar to slide into. The creation and use of these pockets are common for one skilled in the art of kite making. Innovations in pocket design patents include. (U.S. Pat. No. 4,787,575) The function of stretching the sail material along the length of a kite's structural members is commonly accomplished with a notched end and the use of elastic and is shown in U.S. Pat. No. 4,736,914. Structural member connectors have shown innovation by the use of specialized connectors as shown in U.S. Pat. No. 4,958,787. In U.S. Pat. No. 5,011,099 a zipper clamp is used to adjust keel depth. The present invention's use of a zipper is unrelated to adjustments but rather the ease of disassembling a kite and interchangeability of kite material on a common set of structural spars. The Zipper connection also securely attaches the desired part of kite material to the structural spars that renders the use of specialized pocket ends and elastic material as in U.S. Pat. No. 4,736,914 obsolete. The present invention also serves as to interchange kite material similar to U.S. Pat. No. 5,938,150 where the material is clamped to it's structural spars and doesn't require any special material construction such as a zipper to interchange material.

### SUMMARY OF THE INVENTION

The present invention comprises one functional addition to kite material and spars. This invention uses a zipper rather than kite sail material pockets to attach the structural spars to the kite material. This invention is specific to the functional kite spars and the sail material that attaches to them. One side of the zipper is attached permanently or non-permanently to kite spars. The other side of the zipper is permanently attached to the kite material. This allows easy disassembly of the kite material from its structural spars. This also functionally attaches the desired portion of kite material to its structural spar without the use of pockets or material stretching.

### DETAILED DESCRIPTION OF DRAWINGS

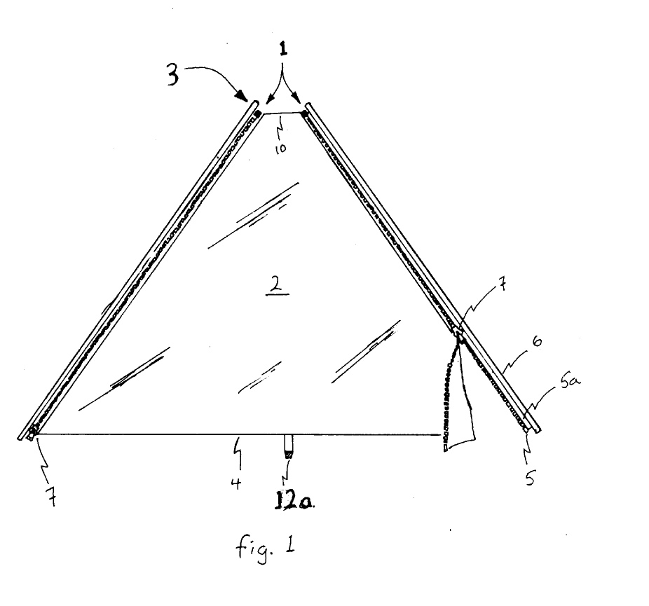

FIG. 1 is a front view of a delta shaped kite with two wing spars connected to the sail material with zippers. The spar on the right is partially unzipped allowing the wing material to fall freely. In the figure the leading edge 10 of the delta shaped kite at the front of the trailing edge 4. The invention 1 is the zipper connection between material 2 and wing spar assembly 3.

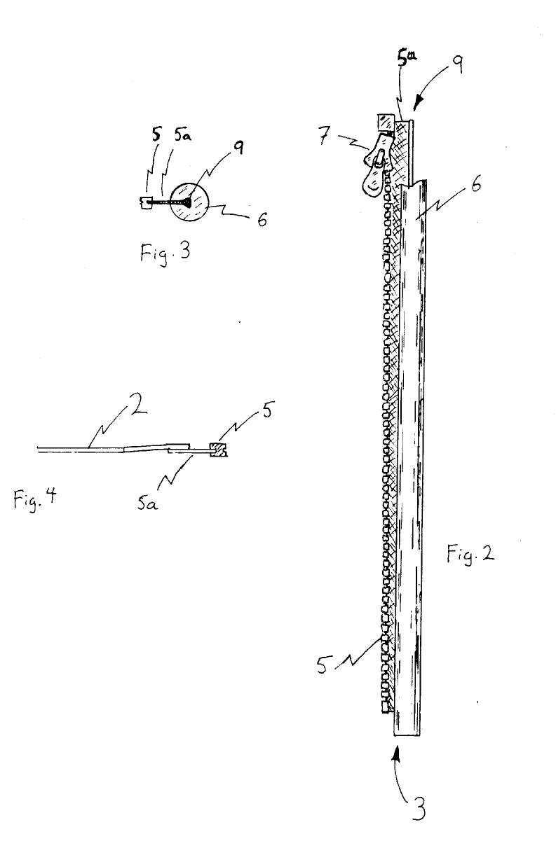

FIG. 2 is a detailed view of the wing spar assembly 3. The drawing shows a half of a zipper 5 with its flexible part 5a being held permanently by a cylindrical solid extruded kite spar 6. The attachment means 9 is a permanently connected zipper pulled into the extruded spar and glued permanently 6.

FIG. 3 is a close up cross section view of the spar assembly 3. This view shows the means 9 for connecting the flexible part of the zipper 5a to the spar 6. This shows that one embodiment of the means is for the zipper to be held from within the spar and glued into place.

FIG. 4 is a close cross section view of the kite material 2 attached to the flexible portion of the zipper 5a.

FIG. 5 is a detailed view of another embodiment the spar assembly 3 where the zipper 5 is attached to flexible material 11 surrounding the spar and sewed onto the flexible portion of a zipper.

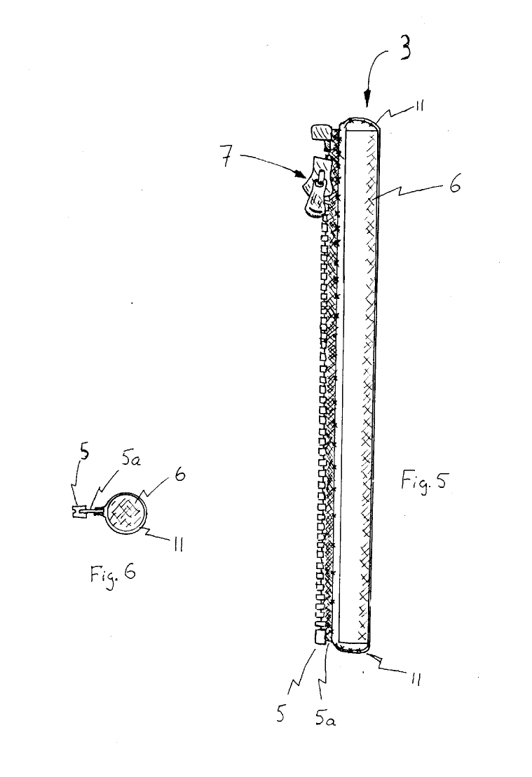

FIG. 6 shows a close up cross section view of the material 11 that surrounds the spar 6 and is sewed onto the flexible part of the zipper 5a.

FIG. 7 is a perspective view of the back of a delta kite in flight the zippers 1 are hidden from the front because the material is pulled around the spar and being held n the pulled position by the cross spar 12. The center spar 12a is fully exposed from the back.

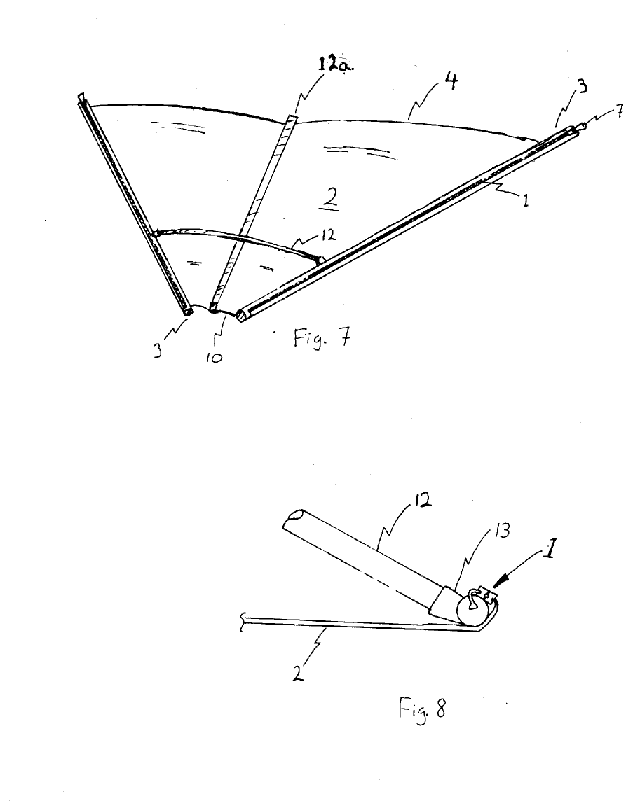

FIG. 8 is a detailed view of a means of connection 13 between the wing spar 6 and the cross spar 12. The means strut connection is unrelated to the invention. But this configuration causes the material 2 to be pulled around the spar to hide the connected zipper 1 from front view.

We claim:

1. A zipper that connects a kite's structural spars to its sail material.

2. Half of a zipper attached to a kite's structural spar for the purpose of zipping on kite sail material.

3. Half of a zipper attached to kite sail material that connects said material to its structural spars.

4. A zipper that functionally attaches kite sail material to its structural spars.
